(19) United States
(12) Patent Application Publication
(10) Pub. No.: US 2014/0278108 A1
(43) Pub. Date: Sep. 18, 2014

(54) Methods and Systems for Optical Flow Modeling Applications for Wind and Solar Irradiance Forecasting

(71) Applicants: Shawn Kerrigan, Redwood City, CA (US); Sergey Koltakov, Palo Alto, CA (US); Matthew Williams, San Francisco, CA (US); Alexander Thornton, San Francisco, CA (US)

(72) Inventors: Shawn Kerrigan, Redwood City, CA (US); Sergey Koltakov, Palo Alto, CA (US); Matthew Williams, San Francisco, CA (US); Alexander Thornton, San Francisco, CA (US)

(73) Assignee: Locus Energy, LLC

(21) Appl. No.: 14/077,797

(22) Filed: Nov. 12, 2013

Related U.S. Application Data
(60) Provisional application No. 61/778,537, filed on Mar. 13, 2013.

(51) Int. Cl. G01W 1/02

(52) U.S. Cl. CPC G01W 1/02
USPC 702/3

(57) ABSTRACT

A method of forecasting cloud motion: gathering a time-series of satellite imagery; transforming the time-series of satellite imagery into a cloudiness index image by establishing an upper and lower limit of visible pixel values for time t; calculating the cloudiness index at each pixel location for time t to provide a cloudiness index image; applying optical flow modeling to the cloudiness index image by assuming pixel value constancy across time; assuming motion to be small and approximating the motion with a Taylor series; assuming vector field is smooth locally; selecting all pixels within d distance of location n with the same prior vector field (m*m pixels); solving system of m*m equations in the least square sense; repeat at multiple resolutions; and calculating cloud motion vectors from multiple resolution vector fields; applying the cloud motion vectors to the cloudiness index image to predict future cloud position and intensity.

This application relates generally to systems and methods for estimating wind speed and direction, forecasting cloud motion and forecasting solar irradiance by applying optical flow models to satellite imagery of sky imagery.

In recent years, the number of operational solar energy installations has grown rapidly at the residential, commercial, and utility scale. While in aggregate solar power generation is still only a small percentage of the energy produced in the United States, the volatility of solar power production causes it to have a disproportionate impact on the electric grid. For grid operators to efficiently manage and plan for the integration of high penetration solar into the electric grid, the current and near-future irradiance available within a region needs to be understood. For these forecasts to be effectively used, the forecasts must be highly accurate.

Historically, solar irradiance forecasts were largely considered a byproduct of meteorological forecast models and therefore have been typically of low accuracy. The demand for solar irradiance forecasts has increased and there currently exist a number of forecast models with a variety of underlying methodologies, but cross-disciplinary innovation in the field has been limited. Cloud motion based solar irradiance forecasts have been one of the areas of innovation, but the models have been limited to drawing from Bayesian statistics. A novel computer vision based methodology for calculating cloud motion vectors (wind speed and direction) and predicting cloud position by applying optical flow models is described. Additionally, the methodology for using predicted cloud position to estimate solar irradiance is also described.

Solar irradiance has impact across a variety of scientific fields including but not limited to meteorology, agronomy, and solar power. In meteorology, irradiance is absorbed by Earth's surface as heat, affecting the global mean temperature. In agronomy, irradiance causes growth in plants as well as impacting transpiration. In solar power, irradiance converts to electricity via the photovoltaic effect or it heats water for solar thermal energy. In addition to these examples, solar irradiance influences countless physical processes, thus illustrating the need for accurate sources of irradiance.

Solar power is a rapidly growing source of power generation that faces many challenges to full integration into the electric grid. Intermittency of power production is inherent to solar power due to constantly changing weather conditions and consequently solar resource availability, and this is largest challenge facing solar power integration. By forecasting atmospheric conditions and modeling solar irradiance using these conditions, future volatility can be predicted. Using solar irradiance forecasts, grid operators can intelligently plan for intermittency and mitigate the resulting impacts, thus illustrating the need for accurate solar irradiance forecasts.

There exist many variants of solar irradiance forecast models, ranging from time series forecasting to numerical weather prediction. For short term forecasting, cloud motion based models have proven most accurate. Cloud motion models estimate wind speed and direction by calculating the cloud motion vectors from a time-series of satellite imagery, enabling future cloud positions to be predicted. Existing cloud motion forecast models are based on Bayesian statistics and fail to take advantage of relevant cross-disciplinary advances in computer vision. A novel cloud motion forecast model based on optical flow modeling has proven to be more accurate than Bayesian based models. The superior computer vision based cloud motion forecast model enables more accurate solar irradiance forecasts.

The present invention provides methods and systems to calculate cloud motion vectors and forecast cloud position from satellite imagery or sky imagery using optical flow models. Also described is the methodology for using optical flow based cloud motion forecasts to predict atmospheric conditions for solar irradiance forecasting.

These and other features, aspects and advantages of the present invention will become better understood with reference to the following description and claims.

### SUMMARY OF THE INVENTION

The present invention relates to methods and systems for calculating cloud motion vectors and forecast cloud position from satellite imagery or sky imagery using optical flow models. Also provided are systems and methods for using optical flow based cloud motion forecasts to predict atmospheric conditions for solar irradiance forecasting.

According to one embodiment of the present invention, a computer processor implemented method of forecasting cloud motion is provided, the method comprising the steps of: gathering a time-series of satellite imagery including at least one of a time-series of visible satellite imagery and a time-series of infrared satellite imagery; transforming the time-series of satellite imagery, by a computing device, including at least one of a time-series of visible satellite imagery and a time-series of infrared satellite imagery into a cloudiness index image by establishing a lower limit of visible pixel values for time t; establishing an upper limit of visible pixel values for time t; and calculating the cloudiness index at each pixel location for time t to provide a cloudiness index image; applying optical flow modeling, by a computing device, to the cloudiness index image by assuming pixel value constancy across time; assuming motion to be small and approximating the motion with a Taylor series; assuming vector field is smooth locally; selecting all pixels within d distance of location n with the same prior vector field (m*m pixels); solving system of m*m equations in the least square sense; repeat at multiple resolutions the step of solving system of m*m equations in least square sense; and calculating cloud motion vectors from multiple resolution vector fields; applying the cloud motion vectors, by a computing device, to the cloudiness index image to predict future cloud position and intensity.

According to another embodiment of the present invention, a method of forecasting cloud motion is provided, the method comprising the steps of: gathering a time-series of sky imagery including at least one of a time-series of visible sky imagery and a time-series of infrared sky imagery; transforming the time-series of sky imagery, by a computing device, including at least one of a time-series of visible sky imagery and a time-series of infrared sky imagery into a cloudiness index image by establishing a lower limit of visible pixel values for time t; establishing an upper limit of visible pixel values for time t; and calculating the cloudiness index at each pixel location for time t to provide a cloudiness index image; applying optical flow modeling to the cloudiness index image, by a computing device, by assuming pixel value constancy across time; assuming motion to be small and approximating the motion with a Taylor series; assuming vector field is smooth locally; selecting all pixels within d distance of location n with the same prior vector field (m*m pixels); solving system of m*m equations in the least square sense; repeat at multiple resolutions the step of solving system of m*m equations in least square sense; and calculating cloud motion vectors from multiple resolution vector fields; applying the cloud motion vectors, by a computing device, to the cloudiness index image to predict future cloud position and intensity.

According to another embodiment of the present invention, a method of forecasting solar irradiance using optical flow based cloud motion forecasts is provided, the method comprising the steps of: determining a cloudiness index value transformed from at least one of satellite imagery and sky imagery and generated by a cloud forecasting model at location n at time t; applying, by a computing device, a motion vector of a pixel obtained from the cloud forecasting model for a time period length i at location n at time t and at respective locations to the cloudiness index value to forecast each cloudiness index at a forecasted location of pixel and a time of forecast to provide a forecasted cloudiness index; Inputting, in a computing device, the forecasted cloudiness index as input to a solar irradiance model to estimate solar irradiance at location o at time u.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

FIG. 6 depicts the present invention;

FIG. 7 depicts the present invention;

FIG. 8 depicts the present invention;

FIG. 9 depicts the present invention;

FIG. 10 depicts the present invention;

FIG. 11 depicts the present invention;

FIG. 12 depicts the present invention;

FIG. 13 depicts the present invention; and

FIG. 14 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

FIGS. 1-5 provide examples of a monitored renewable energy system (more specifically a photovoltaic array solar panel also referred to herein as a solar photovoltaic system or solar powered system) from which information may be obtained. According to the example shown, there is a server 10 and at least one monitored renewable energy system (e.g. 102, 104, 106, 108, 110, 112) which is provided to a user or consumer. There may be at least one data server (10), at least one generation monitoring device (16) in communication with the monitored renewable energy system (at premise monitored renewable energy system (30)) and at least one communication node (22) in communication with at least one of the monitored renewable energy system (30), the generation monitoring device (16) and the data server (10). It should be understood the data server may be a single computer, a distributed network of computers, a dedicated server, any computer processor implemented device or a network of computer processor implemented devices, as would be appreciated by those of skill in the art. It should also be understood that each step of the present invention may be performed by a computer/computing device/computer processor or in a computer/computing device/computer processor. The monitored renewable energy system may have background constants that are entered into the system during data setup; populating this part of the data structure is one of the initial steps to the process. During this time, all required (or potentially required) background information may be loaded into the system. This data will later be used for system calculations and diagnostics. Background constants may include: (1) Full Calendar with sunrise and sunset according to latitude throughout the year; (2) Insolation or ‘incident solar radiation’: This is the actual amount of sunlight falling on a specific geographical location. There are expected amounts of radiation which will fall on an area each day, as well as an annual figure. Specific Insolation is calculated as kWh/m2/day. The importance of this variable is that it can combine several other Background Constants; and (3) Location Functionality. It is envisioned that some of this information may be input and some may be determined automatically. The proximity of each system to each other system may be determined, and forms a part of the methods used to determine the geographic average of the renewable energy systems. While there are different specific methods of implementing Location Functionality, generally this relies on a large database of locations which are tied to zones. Because the relational distances between the zones are stored within the software, the distances between any two locations can then be easily and accurately calculated.

The term production data refers to any data that is received from the renewable energy system and/or solar irradiance sensor. The energy generated by each monitored renewable energy system and/or solar irradiance sensor is recorded as production data and the data server may then determine comparative information based upon at least one of the background constant, the diagnostic variable, the system coefficient and the energy generated to determine a comparative value of the monitored renewable energy system. The term comparative value is intended to include any value that compares one system to another system or a group of systems. For example, this may be as simple as an “underperforming” designation when the system's performance is less than another system or group of systems performance in terms of power generated.

A sample system may have at least one inverter (14) in communication with the monitored renewable energy system (e.g. 50, 30). The inverter (14) is an electronic circuit that converts direct current (DC) to alternating current (AC). There may also be at least one return monitor (18) determining the energy returned to a grid by the at-least one monitored renewable energy system. At least one background constant may be determined and saved in the data server(s). The monitored renewable energy system (e.g. 30, 50) may be at least partially powered by at least one alternate energy source. There may be at least one generation monitoring device (e.g. 58), which calculates the energy generated at each consumer's premises by the monitored renewable energy system (e.g. 30, 50); at least one communication node (64) in communication with each at least one generation monitoring device (e.g. 58); at least one data server (10) in communication with communication node (e.g. 64), wherein the data server(s) (10) accept information from the communication node (e.g. 64) to determine the power generated at a first user's premises (100) and compare the power generated at a first user's premises (100) to Comparative Information obtained from at least two monitored renewable energy systems (e.g. 102, 104, 106, 108, 110, 112, 114) to determine if the first user's monitored renewable energy system (100) is within a predetermined deviation from the comparative information. This may provide a comparative value. The communication node may be further comprising a data storage means for storing usage information. For example, the communication node (64) may be a computer with a hard drive that acts as a data storage means for storing usage information. The generation monitoring device may be selected from the group consisting of pulse meter, temperature meter, electromechanical meter, solid state meter, flow meter, electric meter, energy meter and watt meter. There may also be at least one return monitoring device in communication with the inverter which calculates the energy returned to a grid by the system.

The monitored renewable energy system may be, for example, a solar system, solar panel system, photovoltaic, thermal, wind powered, geothermal, hydropower. A secondary energy source (e.g. 52) may be in communication with and at least partially powering the monitored renewable energy system. It should be understood, though, this is only for ancillary power in the event that the renewable energy source (50) is not capable of entirely powering the at premise monitored renewable energy system.

The generation monitoring device may be any type of meter, by way of example, this may include a pulse meter, temperature meter, electromechanical meter, solid state meter, flow meter, electric meter, energy meter and watt meter. An installation will have a communication node or hub set up at the location with the system. One of the communication nodes may act as a hub. These devices connect to the internet and send the data collected by the nodes to the Server. They have the following properties: The hub has a web server and connects to a standard internet connection (Ethernet). It does not require a computer or other device to make this connection. Each hub has its own unique IP or DNS address. The hub is configured by a web browser. The web browser allows the hub to have specific nodes assigned to it. This set up feature will allow another hub in the area to be set up with its own nodes so that all can operate wirelessly without disruption. Also, the hub is able to configure specific aspects of the hub, such as the connection with the server, data recording and time settings and the ability to configure the attached nodes, including their recording properties.

Each installation may have two or more Data Nodes. These are typically connected wirelessly to the Hub, and connected directly to the inputs/outputs from the Solar Hot Water system. They communicate constantly with the Hub, transferring data which the Hub then sends up to the server. They may have the following properties: The first Required Node connects to a flow meter attached to the Water Tank that is connected to the Solar Hot Water system. This Node will operate as a pulse meter, ‘clicking’ whenever a unit (either a gallon or a liter) of hot water passes from the tank. The second Required Node connects to either the electric panel at the switch for the Hot Water tank's electric power OR to a flow/other meter for gas/oil to the secondary heater for the Hot Water tank. The Node may have a data storage means for storing flow/usage information. Together, the data gathered from these Required Node connections allow the software on the serve to convert the utilized hot water into an accurate reading of utilized solar energy by subtracting the energy required to by the secondary heating mechanism. The term utilized generation refers to the energy generated by the at-premise power system, less any energy that has not been consumed by the at premise power system (e.g. the energy used to heat water that remains in the tank and is not subsequently used). Note that the term “at-premise power system” is one type of monitored renewable energy system, as claimed. There may also be other Nodes, which may be used to measure other aspects of the system and gain even more accurate readings. For example: the temperature of the hot water on an ongoing basis. The system may be monitored from a remote location (such as a computer in a different location).

The components node (100), hub (102) and server (10) make up the required core components needed to accurately measures the actual usable output from a Solar Hot Water (SHW) system. Essentially, the hub (102) connects to multiple nodes (100) which simultaneously measure the secondary power going into the system along with the hot water going out. Controlling for any background power requirements (e.g. for pumping), it can measure the usable BTUs created by solar by analyzing the measurements at the server (104) level.

The renewable energy system may be a solar system, solar panel system, photovoltaic, thermal, wind powered, geothermal, hydropower or any other renewable energy system. Also, the terms at-premises, on premises and at-premise are interchangeable and equivalent. Additionally, for those interested in heating and cooling their dwelling via renewable energy, geothermal heat pump systems that tap the constant temperature of the earth, which is around 7 to 15 degrees Celsius a few feet underground, are an option and save money over conventional natural gas and petroleum-fueled heat approaches.

The method may further comprise the steps of: monitoring the system from a remote location; and monitoring the utilized generation from a remote location. The method may comprise the steps of: generating an alert when the customer variables are a prescribed percentage different than historical averages. The method may also comprise the steps of monitoring and storing the consumer's customer variables and utilized generation.

Production data could come from, without limitation, PV System (kW or kWh), Solar thermal system (kW or kWh), Concentrated solar power system (kW or kWh) and Wind turbine (kW or kWh). Sensor data could come from, without limitation, Pyranometer (W/m̂ or Wh/m̂), Pyrheliometer (W/m̂ or Wh/m̂), PV reference cell (W/m̂ or Wh/m̂), Radiometer (W/m̂ or Wh/m̂), Pyrgeometer (W/m̂ or Wh/m̂), Anemometer (mph or m/s). This type of data consists of a hardware measurement (units listed beside hardware) and a corresponding point in time or time interval, producing a time series of data (multiple time points and data). For example, monitored PV production data is measured every 5 minutes, resulting in a 1 day dataset containing 288 measurements and timestamp pairs.

The present invention provides methods and systems for validating and augmenting solar irradiance and solar power production forecasts using a monitored network of solar power systems and solar irradiance sensors. Solar irradiance has impact across a variety of scientific fields including but not limited to meteorology, agronomy, and solar power. In meteorology, irradiance is absorbed by Earth's surface as heat, affecting the global mean temperature. In agronomy, irradiance causes growth in plants as well as impacting transpiration. In solar power, irradiance converts to electricity via the photovoltaic effect or it heats water for solar thermal energy. These are only a few of countless examples of physical processes influenced by solar irradiance, each further emphasizing the need for accurate sources of irradiance measurements.

Solar power is a rapidly growing source of power generation that faces many challenges to full integration into the electric grid. Intermittency of power production is inherent to solar power due to constantly changing weather conditions, and this is the largest challenge facing solar power. By forecasting weather conditions and modeling solar power output using these conditions, future volatility can be predicted. Using solar power forecasts, grid operators can intelligently plan for intermittency and mitigate the resulting impacts, hence the need for accurate solar power forecasts.

There exist many variants of solar irradiance forecast models, ranging from cloud motion forecasting to numerical weather prediction. FIG. 7 depicts a Solar Irradiance model graphic. The standard practice for irradiance forecast models is to provide model accuracy using a historical test period of data, resulting in the use of stale accuracy metrics in planning for model error. Additionally, these models generate new forecasts at low temporal resolution fixed intervals, typically relying on historical data from distantly related data sources for changes in the model. The inability of these models to incorporate a continuous stream of new input data is a flaw that can be remedied according to the present invention using adaptive statistical techniques.

Extensive scientific research has been conducted and published in the field of solar power modeling. These published models are based on the physics of the underlying solar power technology and have been tested in laboratories and in the field. Existing models, such as the single-diode model for photovoltaic systems have proven to be fairly accurate. While accurate, these models suffer from non-random errors that could potentially be reduced with statistical post-processing.

There is a clear and present need for high accuracy forecasts of solar irradiance and solar power production. Existing models have proven effective but they suffer from a number of flaws. One key fault of existing forecast models is an inability to continuously validate and augment forecasts in real-time. Additionally, these models do not leverage measurements from solar power systems or solar irradiance sensors, the most closely related sources of data for forecasts. The present invention provides methodology to validate the accuracy of solar irradiance and solar power forecasts in real-time. Also described is the methodology for applying machine learning techniques to augment solar irradiance and solar power forecasts using measurements from a monitored network of solar power installations and weather sensors and modeled variables from related computer models.

The present invention may utilize the following background variables, input parameters and logic based on those variables and parameters.

FORECAST VALIDATION LOGIC: This is logic for validating the accuracy of a forecast model. By comparing a subset of estimates from a forecast for which there exists corresponding sensor measurements, a validation metric of the overall forecast can be quantified.

FORECAST AUGMENTATION LOGIC: This is logic for augmenting estimates from a forecast model using measured and modeled data. By applying machine learning techniques to expired forecasts, observations, and other related variables, active forecasts can be augmented to reduce errors caused by hidden patterns in the underlying forecasting mechanism.

SOLAR IRRADIANCE FORECAST FEED: This is nowcasted and forecasted solar irradiance data obtained from an internet data feed and/or internal data feed. The feed includes global horizontal irradiance, direct normal irradiance, and diffuse horizontal irradiance, among other variables.

SOLAR POWER PRODUCTION FORECAST FEED: This is nowcasted and forecasted solar power production data obtained from an internet data feed and/or internal data feed. The feed includes AC power, current, and voltage among other variables.

SOLAR POWER PRODUCTION DATA FEED: This is power production data that is obtained from an internet data feed and/or a network of monitored solar power installations. The feed includes AC power, current, and voltage, among other variables. This data is obtained from physical hardware, including but not limited to a power meter or inverter.

WEATHER DATA FEED: This is weather data that is obtained from an internet data feed and/or a network of monitored weather sensors. The feed includes solar irradiance, snow cover, ambient temperature, wind speed, and dew point, among other variables. This data is estimated from computer models or measured by physical hardware, including but not limited to a pyranometer or solar panel for solar irradiance, a thermometer for temperature, and an anemometer for wind speed.

SATELLITE IMAGERY FEED: This is environmental imagery that is obtained from an internet data feed and/or monitored satellites. The feed includes visible spectrum imagery and infrared spectrum imagery, and the data contained in this imagery includes albedo and brightness temperature, among other variables. This imagery is captured by geosynchronous environmental satellites.

SOLAR IRRADIANCE MODEL: This is a quasi-empirical computer model that estimates solar irradiance using a proxy for atmospheric conditions. The atmospheric conditions proxy can be obtained from sources including but not limited to imagery from a satellite or sky imager, measurements from a weather sensor, and estimates from a computer model. Data from this model includes, but is not limited to solar irradiance, solar geometry, and atmospheric variables.

SOLAR POWER PRODUCTION MODEL: This is a physics-based computer model that converts weather data into solar power based on a solar installation's configuration (i.e. hardware, orientation, installation derates, etc.).

SOLAR IRRADIANCE FROM SOLAR POWER PRODUCTION MODEL: This is a quasi-empirical computer model that estimates the solar irradiance at the location of a solar power system. Using measurements of solar power production, a solar power production model can be reversed in order to estimate the solar irradiance received.

LOCATION & TIME VARIABLES: These are various variables corresponding to a location and time. These variables include latitude, longitude, altitude, date, and time, among other variables.

VALIDATION METRIC CALCULATIONS: These are formulas that calculate the statistical accuracy of models. These metrics include, but are not limited to, model error, mean absolute error, and root mean square error.

MACHINE LEARNING ALGORITHMS: These are algorithms that use an input dataset to adaptively generate predictions based on historical underlying relationships between the input and output. These algorithms include, but are not limited to, artificial neural networks and genetic algorithms. FIG. 8 depicts an Artificial Neural Network Example

CLOUD MOTION VECTOR LOGIC: This is logic for estimating wind speed and direction through calculation of cloud motion vectors. Since wind drives the movement of clouds, speed and direction can be approximated by calculating the cloud motion vectors from a time-series of imagery.

CLOUD MOTION FORECASTING LOGIC: This is logic for forecasting the motion of clouds in an image. By applying optical flow algorithms to a time series of imagery, the motion vectors of clouds can be determined. Using these motion vectors, future cloud positions can be predicted for any point in near future.

CLOUD MOTION BASED SOLAR IRRADIANCE FORECASTING LOGIC: This is logic for forecasting solar irradiance using cloud motion forecasting. By forecasting cloud motion of a satellite image or sky image, future atmospheric conditions at a location can be determined. The forecasted atmospheric conditions are used by a solar irradiance forecast model in order to predict solar irradiance.

SATELLITE IMAGERY FEED: This is imagery that is obtained from an internet data feed or a monitored satellite. The feed includes geolocated satellite imagery in visible and infrared spectrums. This imagery is taken by geosynchronous environmental satellites.

SKY IMAGERY FEED: This is imagery that is obtained from an internet data feed or a monitored sky imager. The feed includes geolocated sky imagery in visible and infrared spectrums. This imagery is taken by ground mounted sky imagers.

WEATHER DATA FEED: This is weather data that is obtained from an internet data feed and/or a network of monitored weather sensors. The feed includes solar irradiance, temperature, wind speed, and dew point among other variables. This data is estimated from computer models or measured by physical hardware, including but not limited to a pyranometer or solar panel for solar irradiance, a thermometer for temperature, and an anemometer for wind speed.

LOCATION & TIME VARIABLES: These are various variables corresponding to a location and time. These variables include latitude, longitude, altitude, date, and time among other variables.

CLOUDINESS INDEX IMAGE TRANSLATION MODEL: This is an empirical model that quantifies a proxy of the cloudiness of the atmosphere. This model creates a 0 to 1 index of cloudiness using visible spectrum imagery and infrared spectrum imagery when available. Using a time-series of imagery, the lower and upper limit visible spectrum pixel values are determined, allowing for the cloudiness index to be created using the current pixel values. Data from this model includes cloudiness index.

CLOUD MOTION FORECAST MODEL: This is an empirical computer model that calculates the motion vectors of clouds from satellite or sky imagery and then forecasts cloud position from the motion vectors. Data from this model includes, but is not limited to, cloud motion vectors and cloud positions.

SOLAR IRRADIANCE MODEL: This is a quasi-empirical computer model that estimates solar irradiance using a proxy for atmospheric conditions. The atmospheric conditions proxy is obtained from cloud motion forecasted imagery generated by a computer model. Data from this model includes, but is not limited to, solar irradiance and cloudiness index.

OPTICAL FLOW ALGORITHMS: These are computer vision algorithms for estimating the motion of image features using a time series of imagery. Examples of these algorithms include, but are not limited to, phase correlation, discrete optimization methods, and differential methods.

Solar Irradiance Forecast Validation Methods. According to one aspect of the present invention, a computer processor implemented method of validating solar irradiance forecasts is provided, the method comprising the steps of; providing a set of renewable energy systems having at least two renewable energy systems each having a measured solar irradiance from a solar irradiance weather sensor at a location n and time t and an estimated solar irradiance from a solar irradiance forecast feed at a location n and time t in a computer processor; determining by the computer processor a set of matched pairs of location and time from the measured solar irradiance from a from weather sensor at a location n and time t and the estimated solar irradiance from a solar irradiance forecast feed at a location n and time t; calculating a validation metric of the set of matched pairs by the computer processor for at least one of: all locations at time t; location n at all times; all locations at all times; a subset of locations at time t; location n at a subset of times; and a subset of locations at a subset of times. The renewable energy system may be a photovoltaic system. The validation metric may be model error, mean absolute error and root mean square error.

Model Error formula.

Model Error=Estimate−Observed.

Mean Absolute Error formula.

$$Mean Absolute Error = \frac{1}{n} {\sum }_{i = n}^{n} \vert {Estimate}_{i} - {Observed}_{i} \vert$$

Root Mean Square Error formula.

$$Root Mean Square Error = \sqrt{\frac{1}{n} {\sum }_{i = 1}^{n} {( {Estimate}_{i} - {Observed}_{i} )}^{2}}$$

The solar irradiance weather sensor may be a pyranometer, pyrheliometer and/or photovoltaic reference cell sensor.

This provides systems and methods for validating solar irradiance forecasts. Using a data feed or monitored weather stations, observed solar irradiance can be compared against forecasted solar irradiance in order to validate the accuracy of a forecast in real-time. A number of metrics for quantifying model accuracy can be used for validation, including but not limited to model error, mean absolute error, and root mean square error.

Definition of Variables

Measured Solar Irradianceₙₜ=Measurement of solar irradiance from a weather sensor at location n and at time t

Forecasted Solar Irradianceₙₜ=Estimate of solar irradiance from a solar irradiance forecast feed at location n and at time t

n=Location of measurement or estimate

t=Time of measurement or estimate

Validation of Solar Irradiance Forecasts

Pair up all Measured Solar Irradiance and Forecasted Solar Irradiance on both location and time

### Example

Measured Solar Irradianceₙₜ and Forecasted Solar Irradianceₙₜ

Calculate validation metric (e.g. model error, mean absolute error, root mean square error, etc.) for any permutation of the sets below:

All locations at time t

Location n at all times

All locations at all times

A subset of locations at time t

Location n at a subset of times

A subset of locations at a subset of times

Solar Power Production Forecast Validation Methods. This aspect of the present invention provides methods and systems for validating solar power production forecasts. Using a data feed or monitored solar power installations, observed solar power production can be compared against forecasted solar power production in order to validate the accuracy of a forecast in real-time. Any metric for quantifying model accuracy can be used for validation including, but not limited to model error, mean absolute error, and root mean square error.

Definition of Variables

Measured Power Productionₙₜ=Measurement of solar power production from a power meter at location n and at time t.

Forecasted Power Productionₙₜ=Estimate of solar power production from a solar power production forecast feed at location n and at time t.

n=Location of measurement or estimate.

t=Time of measurement or estimate.

Validation of Solar Power Production Forecasts

Pair up all Measured Power Production and Forecasted Power Production on both location and time.

### Example

Measured Power Productionₙₜ and Forecasted Power Productionₙₜ.

Calculate validation metric (e.g. model error, mean absolute error, root mean square error, etc.) for any permutation of the sets below:

All locations at time t.

Location n at all times.

All locations at all times.

A subset of locations at time t.

Location n at a subset of times.

A subset of locations at a subset of times.

A computer processor implemented method of validating solar power production forecasts may comprise the steps of; providing a set of renewable energy systems having at least two renewable energy systems each having a measured power production from a from power meter at a location n and time t and an estimated solar power production from a solar power production forecast feed at a location n and time t in a computer processor; determining by the computer processor a set of matched pairs of location n and time t from the measured power production from a from power meter at a location n and time t and an estimated solar power production from a solar power production forecast feed at a location n and time t in a computer processor; calculating a validation metric of the set of matched pairs by the computer processor for at least one of: all locations at time t; location n at all times; all locations at all times; a subset of locations at time t; location n at a subset of times; and a subset of locations at a subset of times. The renewable energy system may be a photovoltaic system. The validation metric may be selected from the group consisting of model error, mean absolute error and root mean square error.

Solar Irradiance Forecast Augmentation Methods and Systems. FIG. 10 depicts a flowchart for Solar Power Production Forecast Augmentation.

This provides methods and systems for augmenting solar irradiance forecasts. Using a data feed or a network of monitored weather stations and solar power installations, solar irradiance forecasts can be augmented in real-time. By applying machine learning algorithms to data measured by satellites, weather stations, and solar power projects and data modeled by relevant computer models, patterns in forecast model errors can be adaptively identified and minimized through forecast augmentation. A number of machine learning algorithms can be used to augment forecasts, such as artificial neural networks, genetic algorithms, and support vector machines.

Definition of Variables

Measured Solar Irradianceₙₜ=Measurement of solar irradiance from a weather sensor at location n and at time t.

Brightness Temperatureₙₜ=Measurement or estimate of infrared brightness temperature from a satellite or computer model at location n and at time t.

Snow Coverₙₜ=Dummy variable representing snow cover (1 for snow and 0 for none) estimated from a satellite and weather stations or a computer model at location n and at time t

Ambient Temperatureₙₜ=Measurement or estimate of ambient temperature from a weather sensor or computer model at location n and at time t

Humidityₙₜ=Measurement or estimate of humidity from a weather sensor or computer model at location n and at time t

Dew Pointₙₜ=Measurement or estimate of humidity from a weather sensor or computer model at location n and at time t

Wind Speedₙₜ=Measurement or estimate of wind speed from a weather sensor or computer model at location n and at time t

Air Pressureₙₜ=Measurement or estimate of air pressure from a weather sensor or computer model at location n and at time t

Extraterrestial Solar Irradianceₙₜ=Estimate of solar irradiance reaching Earth's atmosphere from at a computer model at location n and at time t

Sun Earth Distanceₙₜ=Estimate of distance between Sun and Earth from a computer model at location n and at time t

Declinationₙₜ=Estimate of the angle between Earth's axis and plane perpendicular to line between the Sun and Earth from a computer model at location n and at time t

HourAngleₙₜ=Estimate of the angular displacement of the Sun east or west of a point's longitude from a computer model at location n and at time t

Zenith Angleₙₜ=Estimate of the angle of the Sun relative to a line perpendicular to the Earth's surface from a computer model at location n and at time t

Solar Elevationₙₜ=Estimate of the angle between the Sun and horizon for a point on Earth from a computer model at location n and at time t

Air Massₙₜ=Estimate of air mass from a computer model at location n and at time t

Turbidityₙₜ=Estimate of turbidity from a computer model at location n and at time t

Cloudiness Indexₙₜ=Estimate of atmospheric cloudiness from a computer model at location n and at time t

Clear Sky Irradianceₙₜ=Estimate of solar irradiance reaching location n and at time t under clear sky conditions from a computer model

Estimated Solar Irradianceₙₜ=Estimate of solar irradiance from a solar irradiance from solar power model using measured solar power from a meter at location n and at time t

Altitudeₙₜ=Measurement or estimate of humidity from a weather sensor or computer model at location n and at time t

Hour of Dayₙₜ=Hour of day at location n and at time t

Month of Yearₙₜ=Month of year at location n and at time t

Forecasted Solar Irradianceₙₜ=Estimate of solar irradiance from a solar irradiance forecast feed at location n and at time t

n=Location of measurement or estimate

t=Time of measurement or estimate

d=Distance from location n for which all enclosed locations are used to augment estimates at location n

s=Time periods behind time t for which all enclosed time periods are used to augment estimates at time t

Augmentation of Solar Irradiance Forecasts

Match up all data at location n and at time t, including all locations within distance d of location n and all time periods within s time periods of time t at those locations. Data includes (where available):

Measured Solar Irradianceₙₜ₋₁, . . . Measured Solar Irradianceₙₜ₋ₛ

Estimated Solar Irradianceₙₜ₋₁, . . . Estimated Solar Irradianceₙₜ₋ₛ

Forecasted Solar Irradianceₙₜ, . . . Forecasted Solar Irradianceₙₜ₋ₛ

Brightness Temperatureₙₜ, . . . Brightness Temperatureₙₜ₋ₛ

Ambient Temperatureₙₜ, . . . Temperatureₙₜ₋ₛ

Humidityₙₜ, . . . Humidityₙₜ₋ₛ

Dew Pointₙₜ, . . . Dew Pointₙₜ₋ₛ

Wind Speedₙₜ, . . . Wind Speedₙₜ₋ₛ

Air Pressureₙₜ, . . . Air Pressureₙₜ₋ₛ

Extraterrestrial Solar Irradianceₙₜ, . . . Extraterrestrial Solar Irradianceₙₜ₋ₛ

Sun Earth Distanceₙₜ, . . . Sun Earth Distanceₙₜ₋ₛ

Declinationₙₜ, . . . Declinationₙₜ₋ₛ

Hour Angleₙₜ, . . . Hour Angleₙₜ₋ₛ

Zenith Angleₙₜ, . . . Zenith Angleₙₜ₋ₛ

Air Massₙₜ, . . . Air Massₙₜ₋ₛ

Turbidityₙₜ, . . . Turbidityₙₜ₋ₛ

Cloudiness Indexₙₜ, . . . Cloudiness Indexₙₜ₋ₛ

Clear Sky Irradianceₙₜ, . . . Clear Sky Irradianceₙₜ₋ₛ

Altitudeₙₜ, . . . Altitudeₙₜ₋ₛ

Hour of Dayₙₜ, . . . Hour of Dayₙₜ₋ₛ

Month of Yearₙₜ, . . . Month of Yearₙₜ₋ₛ

The method comprises the step of training a machine learning algorithm to minimize:

Σᵢ₌₁^{j}Measured Solar Irradianceₙᵢ−\hat{f}(•ₙᵢ)

Where j is the number of time points for which data is available to train the algorithm. Where •ni is the dataset described in step 1 for location n at time i. Where \hat{f}(•ₙᵢ) is a function for predicting solar irradiance at location n at time i using data •ni.

The next step may be to augment Forecasted Solar Irradianceₙₜ using the trained machine learning algorithm:

Augmented Forcasted Solar Irradianceₙₜ=\hat{f}(•ₙᵢ)

Where •nt is the dataset described in step 1 for location n at time t. Where \hat{f}(•ₙᵢ) is a function for predicting solar irradiance at location n at time t using data •nt.

Another aspect of the present invention provides a computer processor implemented method of augmenting solar irradiance forecasts, the method comprising the steps of; providing in a computer processor a set of solar irradiance sensors having at least two solar irradiance sensors each having a measurement of solar irradiance at location n and at time t and forecasted solar irradiance data at location n and at time t; determining in the computer processor at least one set of solar irradiance data variables at a location n and time t; matching by the computer processor all data variables at location n and time t, including all locations within distance d of location n and all time periods with s time periods of time t at those locations to provide a matched set of solar irradiance data variables at a location n and time t; training a machine learning algorithm to minimize to provide a trained machine learning algorithm according to: Σᵢ₌₁^{j}Measured Solar Irradianceₙᵢ−\hat{f}(•ₙᵢ) where j is the number of time points for which data is available to train the algorithm, •nt is the matched set of solar irradiance data variables at a location n and time t and \hat{f}(•ₙᵢ) is a function for predicting solar irradiance at location n at time i using data •ni; augmenting the forecasted solar irradiance data using the trained machine learning algorithm: Augmented Forecasted Solar Irradianceₙₜ=\hat{f}(•ₙᵢ) where •nt is the matched set of solar irradiance data variables at a location n and time t and \hat{f}(•ₙᵢ) is a function for predicting solar irradiance at location n at time t using data •nt. FIG. 9 depicts a flowchart for Solar Irradiance Forecast Augmentation.

The set of solar irradiance data variables may include: estimated solar irradiance data using measured solar power from a meter at location n and time t; forecasted solar irradiance data from a solar irradiance forecast feed at location n and time t; infrared brightness temperatures at location n and time t; ambient temperature at location n and time t; humidity at location n and time t; dew point at location n and time t; wind speed at location n and time t; air pressure at location n and time t; extraterrestrial solar irradiance at location n and time t; sun earth distance at location n and time t; declination at location n and time t; hour angle at location n and time t; zenith angle at location n and time t; air mass at location n and time t; turbidity at location n and time t; cloudiness index at location n and time t; clear sky irradiance at location n and time t; altitude at location n and time t; hour of day at location n and time t; and month of year at location n and time t.

Solar Power Production Forecast Augmentation Methods and Systems

This aspect of the present invention provides systems and methods for augmenting solar power production forecasts. Using a data feed or a network of monitored weather stations and solar power installations, solar power production forecasts can be augmented in real-time. By applying machine learning algorithms to data measured by satellites, weather stations, and solar power projects, as well as data modeled by relevant computer models, patterns in forecast model errors can be adaptively identified and minimized through forecast augmentation. A number of machine learning algorithms can be used to augment forecasts, such as artificial neural networks, genetic algorithms, and support vector machines.

Definition of Variables

Measured Solar Irradianceₙₜ=Measurement of solar irradiance from a weather sensor at location n and at time t.

Measured Power Productionₙₜ=Measurement of solar power production from a meter at location n and at time t.

Brightness Temperatureₙₜ=Measurement or estimate of infrared brightness temperature from a satellite or computer model at location n and at time t.

Snow Coverₙₜ=Dummy variable representing snow cover (1 for snow and 0 for none) estimated from a satellite and weather stations or a computer model at location n and at time t.

Ambient Temperatureₙₜ=Measurement or estimate of ambient temperature from a weather sensor or computer model at location n and at time t.

Humidityₙₜ=Measurement or estimate of humidity from a weather sensor or computer model at location n and at time t.

Dew Pointₙₜ=Measurement or estimate of humidity from a weather sensor or computer model at location n and at time t.

Wind Speedₙₜ=Measurement or estimate of wind speed from a weather sensor or computer model at location n and at time t.

Air Pressureₙₜ=Measurement or estimate of air pressure from a weather sensor or computer model at location n and at time t.

Extraterrestial Solar Irradianceₙₜ=Estimate of solar irradiance reaching Earth's atmosphere from at a computer model at location n and at time t.

Sun Earth Distanceₙₜ=Estimate of distance between Sun and Earth from a computer model at location n and at time t.

Declinationₙₜ=Estimate of the angle between Earth's axis and plane perpendicular to line between the Sun and Earth from a computer model at location n and at time t.

Hour Angleₙₜ=Estimate of the angular displacement of the Sun east or west of a point's longitude from a computer model at location n and at time t.

Zenith Angleₙₜ=Estimate of the angle of the Sun relative to a line perpendicular to the Earth's surface from a computer model at location n and at time t.

Solar Elevationₙₜ=Estimate of the angle between the Sun and horizon for a point on Earth from a computer model at location n and at time t.

Air Massₙₜ=Estimate of air mass from a computer model at location n and at time t.

Turbidityₙₜ=Estimate of turbidity from a computer model at location n and at time t.

Cloudiness Indexₙₜ=Estimate of atmospheric cloudiness from a computer model at location n and at time t.

Clear Sky Irradianceₙₜ=Estimate of solar irradiance reaching location n and at time t under clear sky conditions from a computer model.

Estimated Solar Irradianceₙₜ=Estimate of solar irradiance from a solar irradiance from solar power model using measured solar power from a meter at location n and at time t.

Altitudeₙₜ=Measurement or estimate of humidity from a weather sensor or computer model at location n and at time t.

Hour of Dayₙₜ=Hour of day at location n and at time t.

Month of Yearₙₜ=Month of year at location n and at time t.

Forecasted Solar Irradianceₙₜ=Estimate of solar irradiance from a solar irradiance forecast feed at location n and at time t.

Forecasted Power Productionₙₜ=Estimate of solar power production from a solar power production forecast feed at location n and at time t.

n=Location of measurement or estimate.

t=Time of measurement or estimate.

d=Distance from location n for which all enclosed locations are used to augment estimates at location n.

s=Time periods behind time t for which all enclosed time periods are used to augment estimates at time t.

Augmentation of Solar Power Production Forecasts

Match up all data at location n and at time t, including all locations within d distance of location n and all time periods within s time periods of time t at those locations. Data includes (where available):

Measured Power Productionₙₜ₋₁, . . . Measured Power Productionₙₜ₋ₛ.

Measured Solar Irradianceₙₜ₋₁, . . . Measured Solar Irradianceₙₜ₋ₛ.

Estimated Solar Irradianceₙₜ₋₁, . . . Estimated Solar Irradianceₙₜ₋ₛ.

Forecasted Solar Irradianceₙₜ, . . . Forecasted Solar Irradianceₙₜ₋ₛ.

Forecasted Power Productionₙₜ, . . . Forecasted Power Productionₙₜ₋ₛ.

Brightness Temperatureₙₜ, . . . Brightness Temperatureₙₜ₋ₛ.

Snow Coverₙₜ, . . . Snow Coverₙₜ₋ₛ.

Ambient Temperatureₙₜ, . . . Temperatureₙₜ₋ₛ.

Humidityₙₜ, . . . Humidityₙₜ₋ₛ.

Dew Pointₙₜ, . . . Dew Pointₙₜ₋ₛ.

Wind Speedₙₜ, . . . Wind Speedₙₜ₋ₛ.

Air Pressureₙₜ, . . . Air Pressureₙₜ₋ₛ.

Extraterrestrial Solar Irradianceₙₜ, . . . Extraterrestrial Solar Irradianceₙₜ₋ₛ.

Sun Earth Distanceₙₜ, . . . Sun Earth Distanceₙₜ₋ₛ

Declinationₙₜ, . . . Declinationₙₜ₋ₛ.

Hour Angleₙₜ, . . . Hour Angleₙₜ₋ₛ.

Zenith Angleₙₜ, . . . Zenith Angleₙₜ₋ₛ.

Air Massₙₜ, . . . Air Massₙₜ₋ₛ.

Turbidityₙₜ, . . . Turbidityₙₜ₋ₛ.

Cloudiness Indexₙₜ, . . . Cloudiness Indexₙₜ₋ₛ.

Clear Sky Irradianceₙₜ, . . . Clear Sky Irradianceₙₜ₋ₛ.

Altitudeₙₜ, . . . Altitudeₙₜ₋ₛ.

Hour of Dayₙₜ, . . . Hour of Dayₙₜ₋ₛ.

Month of Yearₙₜ, . . . Month of Yearₙₜ₋ₛ

The method comprises the step of training a machine learning algorithm to minimize: Σᵢ₌₁^{j}Measured Solar Irradianceₙᵢ−\hat{f}(•ₙᵢ). Where j is the number of time points for which data is available to train the algorithm. Where •ni is the dataset described in step 1 for location n at time i. Where \hat{f}(•ₙᵢ) (is a function for predicting solar power production at location n at time i using data •ni.

The next step may be to Augment Forecasted Power Productionₙₜ using the trained machine learning algorithm: Augmented Forecasted Power Productionₙₜ=\hat{f}(•ₙₜ). Where •ₙₜ, is the dataset described in step 1 for location n at time t, and where \hat{f}(•ₙᵢ) is a function for predicting solar power production at location n at time t using data •ₙₜ.

According to one aspect of the present invention, a computer processor implemented method of augmenting solar power production forecasts, said method comprising the steps of; providing in a computer processor a set of solar power meters having at least two solar power meters each having a measurement of power production at location n and at time t and forecasted power production at location n and at time t; determining in the computer processor at least one set of solar power production data variables at a location n and time t; matching by the computer processor all solar power production data variables at location n and time t, including all locations within distance d of location n and all time periods with s time periods of time t at those locations to provide a matched set of solar power production data variables at a location n and time t; training a machine learning algorithm to minimize to provide a trained machine learning algorithm according to:

Σᵢ₌₁^{j}Measured Solar Irradianceₙᵢ−\hat{f}(•ₙᵢ)

where j is the number of time points for which data is available to train the algorithm, •ni is the matched set of solar power production data variables at a location n and time t and \hat{f}(•ₙᵢ) is a function for predicting solar power production at location n at time i using data •ni; augmenting the forecasted solar power production data using the trained machine learning algorithm: Augmented Forecasted Solar Irradianceₙₜ=\hat{f}(•ₙᵢ); where •nt is the matched set of solar power production data variables at a location n and time t and \hat{f}(•ₙᵢ) is a function for predicting solar power production at location n at time t using data •nt.

The set of solar power production data variables may be selected from the group consisting of: measured solar irradiance data from a meter at location n and time t; estimated solar irradiance data using measured solar power from a meter at location n and time t; forecasted solar irradiance data from a solar irradiance forecast feed at location n and time t; infrared brightness temperatures at location n and time t; snow cover status at location n and time t; ambient temperature at location n and time t; humidity at location n and time t; dew point at location n and time t; wind speed at location n and time t; air pressure at location n and time t; extraterrestrial solar irradiance at location n and time t; sun earth distance at location n and time t; declination at location n and time t; hour angle at location n and time t; zenith angle at location n and time t; air mass at location n and time t; turbidity at location n and time t; cloudiness index at location n and time t; clear sky irradiance at location n and time t; altitude at location n and time t; hour of day at location n and time t; and month of year at location n and time t.

The present invention has many useful applications including, but not limited to, irradiance mapping of a geographic region, evaluation of solar projects and weather modeling.

Irradiance mapping of a geographic region: Sunlight mapping is used across a number of domains, since it is a geographic-based data set which users can apply to their particular problem. Similar to transportation maps, vegetation maps, political maps, etc., the irradiance maps can serve a wide variety of purposes for people needing to understand the geographic relationship, including how the geographic relationship has varied/will vary over time.

Renewable energy evaluations: Forecasts can be used to estimate future output from solar photovoltaic systems. Building evaluations: Forecasts can be used to optimize the building control systems to lower operational costs (e.g., pre-cool the building on the morning of a forecasted sunny day, so as to consume the electrical energy earlier in the day when electric power prices are lower). In civil engineering and hydrology: Forecast irradiance maps can be used to operate forecasting numerical models of snowmelt runoff, an important tool for operating and predicting the water impact on everything from reservoir design for hydropower, dam and flood control infrastructure assessments, water availability for drinking water or agricultural purposes, etc.

Evaluation of solar projects: This is a specific sub-type of the general irradiance mapping use case described above. Electric grid integration: The impact of existing or planned solar projects upon the electric grid can be evaluated by examining changes to load and feeder lines due to solar projects. Using the forecast models described in this patent, existing solar projects can be modeled and planned solar projects can be simulated.

Weather modeling. Snow and ice coverage modeling: As described above in the civil engineering and hydrology section, irradiance has a significant impact on snow melt. The current and forecast irradiance can be used to estimate the amount of snowmelt that will occur, which determines the future state of the remaining snow and ice (i.e., irradiance is a key input to modeling the snow and ice coverage of an area). Estimating the albedo effects from changes in snow melt: Albedo is the reflection coefficient of a surface, and is an important concept in climatology, because it determines how much sunlight energy is absorbed as heat rather than reflected back into space. Snow has a high albedo, since it reflects most light. Since irradiance impacts snow melt, which in turn decreases albedo, which in turn affects the climate, the irradiance model in this patent plays an important role in estimating the future albedo in an area (i.e., the irradiance model can be used to predict snow melt, which can then be used to predict albedo as an input to climate models). Hydrology modeling: The irradiance model can be used to estimate snow melt, which provides input to models or estimates of available water for agriculture, drinking water, and other purposes.

The present invention provides systems and method for calculating cloud motion vectors and forecasting cloud position using optical flow models. Applicable optical flow methodology includes, but is not limited to phase correlation, block-based methods, differential methods, and discrete optimization methods. The method below describes the usage of a differential method (Lukas-Kanade) for cloud motion forecasting.

According to one aspect of the present invention, a computer implemented method of forecasting cloud motion is provided, the method comprising the steps of: gathering a time-series of satellite imagery including at least one of a time-series of visible satellite imagery and a time-series of infrared satellite imagery; transforming the time-series of satellite imagery, by a computing device, including at least one of a time-series of visible satellite imagery and a time-series of infrared satellite imagery into a cloudiness index image by establishing a lower limit of visible pixel values for time t; establishing an upper limit of visible pixel values for time t; and calculating the cloudiness index at each pixel location for time t to provide a cloudiness index image; applying optical flow modeling, by a computing device, to the cloudiness index image by assuming pixel value constancy across time; assuming motion to be small and approximating the motion with a Taylor series; assuming vector field is smooth locally; selecting all pixels within d distance of location n with the same prior vector field (m*m pixels); solving system of m*m equations in the least square sense; repeat at multiple resolutions the step of solving system of m*m equations in least square sense; and calculating cloud motion vectors from multiple resolution vector fields; applying the cloud motion vectors, by a computing device, to the cloudiness index image to predict future cloud position and intensity.

Variables

Visible Satellite Imageryₜ=Visible spectrum satellite image from a satellite imagery feed at time t

Infrared Satellite Imageryₜ=Infrared spectrum satellite image from a satellite imagery feed at time t

Visible Sky Imageryₜ=Visible spectrum sky image from a sky imagery feed at time t

Infrared Sky Imageryₜ=Infrared spectrum sky image from a sky imagery feed at time t

Visible Pixelₙₜ=Visible spectrum reflectivity from an image at location n and time t

Infrared Pixelᵢₙₜ=Infrared spectrum brightness temperature from an image in infrared spectrum i at location n and time t

n=Location of pixel

t=Time of image or pixel

d=Distance from location n for which pixels are include

s=Number of time periods to use for cloudiness index calibration

m=Number of pixels

Satellite Imaqery Cloud Motion Forecasts

The method of using satellite imagery to forecast cloud motion may be summarized as being according to the following steps:
1. Gather a time-series of satellite imagery, including the following images (where available):
   a. Visible Satellite Imageryₜ, . . . , Visible Satellite Imageryₜ₋ₛ
   b. Infrared Satellite Imageryₜ, . . . , Infrared Satellite Imageryₜ₋ₛ
2. Using the data described in step 1, transform the satellite imagery into a cloudiness index image:
   a. Establish lower limit of visible pixel values for time t
   b. Establish upper limit of visible pixel values for time t
   c. Calculate cloudiness index at each pixel location for time t
3. Apply optical flow model to cloudiness index image
   a. Assume pixel value constancy across time
   b. Assume motion to be small and approximate it with a Taylor series
   c. Assume vector field is smooth locally
   d. Select all pixels within d distance of location n with the same prior vector field (m*m pixels)
   e. Solve system of m*m equations in the least square sense
   f. Repeat at multiple resolutions
   g. Calculate cloud motion vectors from multiple resolution vector fields
4. Apply cloud motion vectors to cloudiness index image to predict future cloud position and intensity

According to another aspect of the present invention, a method of forecasting cloud motion is performed according to the steps of: gathering a time-series of sky imagery including at least one of a time-series of visible sky imagery and a time-series of infrared sky imagery; transforming the time-series of sky imagery, by a computing device, including at least one of a time-series of visible sky imagery and a time-series of infrared sky imagery into a cloudiness index image by establishing a lower limit of visible pixel values for time t; establishing an upper limit of visible pixel values for time t; and calculating the cloudiness index at each pixel location for time t to provide a cloudiness index image; applying optical flow modeling to the cloudiness index image, by a computing device, by assuming pixel value constancy across time; assuming motion to be small and approximating the motion with a Taylor series; assuming vector field is smooth locally; selecting all pixels within d distance of location n with the same prior vector field (m*m pixels); solving system of m*m equations in the least square sense; repeat at multiple resolutions the step of solving system of m*m equations in least square sense; and calculating cloud motion vectors from multiple resolution vector fields; applying the cloud motion vectors, by a computing device, to the cloudiness index image to predict future cloud position and intensity.

Sky Imagery Cloud Motion Forecasts

This may be summarized as being according to the following steps:
1. Gather a time-series of sky imagery, including the following images (where available):
   a. Visible Sky Imageryₜ, . . . , Visible Sky Imageryₜ₋ₛ
   b. Infrared Sky Imageryₜ, . . . , Infrared Sky Imageryₜ₋ₛ
2. Using the data described in step 1, transform the sky imagery into a cloudiness index image:
   a. Establish lower limit of visible pixel values for time t
   b. Establish upper limit of visible pixel values for time t
   c. Calculate cloudiness index at each pixel location for time t
3. Apply optical flow model to cloudiness index image
   a. Assume pixel value constancy across time
   b. Assume motion to be small and approximate it with a Taylor series
   c. Assume vector field is smooth locally
   d. Select all pixels within d distance of location n with the same prior vector field (m*m pixels)
   e. Solve system of m*m equations in the least square sense
   f. Repeat at multiple resolutions
   g. Calculate cloud motion vectors from multiple resolution vector fields
4. Apply cloud motion vectors to cloudiness index image to predict future cloud position and intensity

Cloud Motion Forecasting Based Solar Irradiance Algorithm

This provides methods for forecasting solar irradiance using optical flow based cloud motion forecasts. The optical flow based cloud motion forecast model is described above. Applying the cloud motion forecast model enables the prediction of future cloud location and intensity, which are used as input to solar irradiance models.

Definition of Variables

Motion Vectorᵢₙₜ=Motion vector of a pixel obtained from a cloud motion forecasting model for time period length i at location n at time t

Cloudiness Indexₙₜ=Cloudiness index value transformed from satellite or sky imagery and generated by a cloud motion forecasting model at location n at time t

n=Location of pixel

Forecasted location of pixel

t=Time of estimate

u=Time of forecast

i=Time periods between t and u

Cloud Motion Based Solar Irradiance Forecasts

This may be summarized as being according to the following steps:
1. Apply all Motion Vectorᵢₙₜ at respective locations to Cloudiness Indexₙₜ to forecast each Cloudiness Indexₒᵤ
   a. Where Cloudiness Indexₙₜ=Cloudiness Indexₒᵤ for each location n
   b. For each (o,u) pair use Semi-Lagrangian advection scheme to trace back the corresponding Cloud Indexₙₜ
2. Use Cloudiness Indexₒᵤ as input to a solar irradiance model, in order to estimate solar irradiance at location o at time u

The computer implemented method of forecasting solar irradiance using optical flow based cloud motion forecasts, may comprise the steps of: determining a cloudiness index value transformed from at least one of satellite imagery and sky imagery and generated by a cloud forecasting model at location n at time t; applying, by a computing device, a motion vector of a pixel obtained from the cloud forecasting model for a time period length i at location n at time t and at respective locations to the cloudiness index value to forecast each cloudiness index at a forecasted location of pixel and a time of forecast to provide a forecasted cloudiness index; inputting, in a computing device, the forecasted cloudiness index as input to a solar irradiance model to estimate solar irradiance at location o at time u.

In the above methods, the step of calculating the cloudiness index at each pixel location for time t to provide a cloudiness index image may be determined by a computing device using only the time-series of visible satellite imagery and according to the formula:

$$Cloudiness {Index}_{n t} = \frac{Visible {Pixel}_{n t} - Visible Pixel Lower {Limit}_{n t}}{\begin{matrix}Visible Pixel Upper {Limit}_{n t} - \\ Visible Pixel Lower {Limit}_{n t}\end{matrix}}$$

In the above methods, the step of calculating the cloudiness index at each pixel location for time t to provide a cloudiness index image may be determined by a computing device using the time-series of visible satellite imagery and the time-series of infrared satellite imagery and is according to the formula:

$$Cloudiness {Index}_{n t} = {C}_{1} \frac{Pixel {Value}_{n t} - Pixe Value Lower {Limit}_{n t}}{\begin{matrix}Pixel Value Upper {Limit}_{n t} - \\ Pixel Value Lower {Limit}_{n t}\end{matrix}} + {\sum }_{i = 2}^{j} {C}_{i} Infrared {Pixel}_{int}$$

where Cx is a fitted coefficient corresponding to each variable.

In the above methods, the step of assuming pixel value constancy across time may be performed by a computing device according to the formula:

I(x,y,t)=I(x+∂x,y+∂y,t+∂t)

In the above methods, the step of approximating the motion with a Taylor series may be according to at least one of the following Taylor series:

$$a . I ( x + \partial x , y + \partial y , t + \partial t ) = I ( x , y , t )$$

$$b . I ( x + \partial x , y + \partial y , t + \partial t ) = I ( x , y , t ) + \frac{\partial I}{\partial x} \partial x + \frac{\partial I}{\partial y} \partial y + \frac{\partial I}{\partial t} \partial t + Higher Order Terms$$

$$c . \frac{\partial I}{\partial x} \partial x + \frac{\partial I}{\partial y} \partial y + \frac{\partial I}{\partial t} \partial t = 0$$

$$d . \frac{\partial I}{\partial x} \frac{\partial x}{\partial t} + \frac{\partial I}{\partial y} \frac{\partial y}{\partial t} = - \frac{\partial I}{\partial t}$$

$$e . ∇ {I}^{T} \cdot \vec{V} = - {I}_{t}$$

In the above methods, the step of solving system of m*m equations in the least square sense may be according to at least one of the following:

∇I^{T}·\vec{V}=−Iₜ a.

minΣ _{x̅εΩ}W²(\vec{x})[∇I^{T}(\vec{x},t)·\vec{V}+Iₜ(\vec{x},t)]² b.

A^{T}W²A\vec{V}=A^{T}W²b c.

A=[I(x₁), . . . ,I(x_{n•n})]^{T} i.

W=diag(W(x₁), . . . ,W(x_{n•n})) ii.

b=[Iₜ(x₁), . . . ,Iₜ(x_{n•n})]^{T} iii.

In the above methods, the step of calculating cloud motion vectors from multiple resolution vector fields may be according to:

V₄=V₄′+(((V₃′)_{interpolated}+V₂′)_{interpolated}+V₁)_{interpolated}

FIG. 11 depicts a solar production model depicting the standard steps for modeling PV system performance. FIG. 12 depicts a cloud motion forecast model graphic according to the present invention. As can be seen in FIG. 12, cloud motion vectors (1204) may be applied to cloudiness indexes at respective locations from satellite images (1200, 1202) to provide forecasted images (1206) that predict future cloud position and intensity. FIG. 13 provides an optical flow example. Using two snapshots (1300, 1304), representing 2D projections of a volumetric rotating ball, a 2D cloud motion vector field (1306) can be extracted from them. The calculation of motion vectors is possible due to a distinct checkered texture of the ball, a perspective view of which changes over time (1302) from image 1300 to image 1304. A marker is placed in the middle of the visible side of the ball in the earlier image (1300) in order to be able to gauge the direction of rotation. The marker moves to the left on image 1304 due to clockwise rotation of the ball looking from above. The motion vector field, displayed in image 1306, indicates the direction of rotation (from right to left) consistent with the relative location of the marker on images 1300 and 1304. The background texture is static and thus translates into zero motion vectors (1306) for pixel locations corresponding to the background texture in image 1300. FIG. 14 provides a graphic of multiple resolution optical flow estimated (Gaussian Pyramids). The figure displays two Gaussian Pyramids for an earlier image I(t) at the base of the left pyramid and a later image I(t+δt) at the base of the right pyramid. Using original images I(t) and I(t+δt) a downscaling is applied to both of them to generate three corresponding lower resolution images, which form each pyramid. All images are successively down scaled from bottom to top using a Gaussian average. Thus, each pixel at a higher level of the pyramid is an average of the four corresponding neighboring pixels from a higher-resolution image below. Once both Gaussian Pyramids are generated, optical flow computations are applied at all four levels of the pyramid. This process yields four optical flow fields Vᵢ′ (where i=1, . . . , 4) at different resolution that are combined into a single optical flow field V₄. This multi-resolution optical flow estimation allows to effectively capture motion for large displacements across images I(t) and I(t+δt).

It should be understood that the foregoing relates to preferred embodiments of the invention and that modifications may be made without departing from the spirit and scope of the invention as set forth in the following claims.

We claim:

1. A computer implemented method of forecasting cloud motion, said method comprising the steps of:
gathering a time-series of satellite imagery including at least one of a time-series of visible satellite imagery and a time-series of infrared satellite imagery;
transforming the time-series of satellite imagery, by a computing device, including at least one of a time-series of visible satellite imagery and a time-series of infrared satellite imagery into a cloudiness index image by establishing a lower limit of visible pixel values for time t; establishing an upper limit of visible pixel values for time t; and calculating the cloudiness index at each pixel location for time t to provide a cloudiness index image;
applying optical flow modeling, by a computing device, to the cloudiness index image by assuming pixel value constancy across time; assuming motion to be small and approximating the motion with a Taylor series; assuming vector field is smooth locally; selecting all pixels within d distance of location n with the same prior vector field (m*m pixels); solving system of m*m equations in the least square sense; repeat at multiple resolutions the step of solving system of m*m equations in least square sense; and calculating cloud motion vectors from multiple resolution vector fields;
applying the cloud motion vectors, by a computing device, to the cloudiness index image to predict future cloud position and intensity.

2. A method as in claim 1, wherein the step of calculating the cloudiness index at each pixel location for time t to provide a cloudiness index image is determined by a computing device using only the time-series of visible satellite imagery and is according to the formula:
$$Cloudiness {Index}_{n t} = \frac{Visible {Pixel}_{n t} - Visible Pixel Lower {Limit}_{n t}}{\begin{matrix}Visible Pixel Upper {Limit}_{n t} - \\ Visible Pixel Lower {Limit}_{n t}\end{matrix}}$$

3. A method as in claim 1, wherein the step of calculating the cloudiness index at each pixel location for time t to provide a cloudiness index image is determined by a computing device using the time-series of visible satellite imagery and the time-series of infrared satellite imagery and is according to the formula:
$$Cloudiness {Index}_{n t} = {C}_{1} \frac{Pixel {Value}_{n t} - Pixe Value Lower {Limit}_{n t}}{\begin{matrix}Pixel Value Upper {Limit}_{n t} - \\ Pixel Value Lower {Limit}_{n t}\end{matrix}} + {\sum }_{i = 2}^{j} {C}_{i} Infrared {Pixel}_{int}$$
where Cx is a fitted coefficient corresponding to each variable.

4. A method as in claim 1, wherein the step of assuming pixel value constancy across time is performed by a computing device according to the formula:
I(x,y,t)=I(x+∂x,y+∂y,t+∂t)

5. A method as in claim 1, wherein the step of approximating the motion with a Taylor series is according to at least one of the following Taylor series:
$$a . I ( x + \partial x , y + \partial y , t + \partial t ) = I ( x , y , t )$$
$$b . I ( x + \partial x , y + \partial y , t + \partial t ) = I ( x , y , t ) + \frac{\partial I}{\partial x} \partial x + \frac{\partial I}{\partial y} \partial y + \frac{\partial I}{\partial t} \partial t + Higher Order Terms$$
$$c . \frac{\partial I}{\partial x} \partial x + \frac{\partial I}{\partial y} \partial y + \frac{\partial I}{\partial t} \partial t = 0$$
$$d . \frac{\partial I}{\partial x} \frac{\partial x}{\partial t} + \frac{\partial I}{\partial y} \frac{\partial y}{\partial t} = - \frac{\partial I}{\partial t}$$
$$e . ∇ {I}^{T} \cdot \vec{V} = - {I}_{t}$$

6. A method as in claim 1, wherein the step of solving system of m*m equations in the least square sense is according to at least one of the following:
∇I^{T}·\vec{V}=−Iₜ a.
minΣ _{x̅εΩ}W²(\vec{x})[∇I^{T}(\vec{x},t)·\vec{V}+Iₜ(\vec{x},t)]² b.
A^{T}W²A\vec{V}=A^{T}W²b c.
A=[I(x₁), . . . ,I(x_{n•n})]^{T} i.
W=diag(W(x₁), . . . ,W(x_{n•n})) ii.
b=[Iₜ(x₁), . . . ,Iₜ(x_{n•n})]^{T} iii.

7. A method as in claim 1, wherein the step of calculating cloud motion vectors from multiple resolution vector fields is according to:
V₄=V₄′+(((V₃′)_{interpolated}+V₂′)_{interpolated}+V₁)_{interpolated}

8. A method of forecasting cloud motion, said method comprising the steps of:
gathering a time-series of sky imagery including at least one of a time-series of visible sky imagery and a time-series of infrared sky imagery;
transforming the time-series of sky imagery, by a computing device, including at least one of a time-series of visible sky imagery and a time-series of infrared sky imagery into a cloudiness index image by establishing a lower limit of visible pixel values for time t; establishing an upper limit of visible pixel values for time t; and calculating the cloudiness index at each pixel location for time t to provide a cloudiness index image;
applying optical flow modeling to the cloudiness index image, by a computing device, by assuming pixel value constancy across time; assuming motion to be small and approximating the motion with a Taylor series; assuming vector field is smooth locally; selecting all pixels within d distance of location n with the same prior vector field (m*m pixels); solving system of m*m equations in the least square sense; repeat at multiple resolutions the step of solving system of m*m equations in least square sense; and calculating cloud motion vectors from multiple resolution vector fields;
applying the cloud motion vectors, by a computing device, to the cloudiness index image to predict future cloud position and intensity.

9. A method as in claim 8, wherein the step of calculating the cloudiness index at each pixel location for time t to provide a cloudiness index image is determined by a computing device using the time-series of visible satellite imagery and the time-series of infrared satellite imagery and is according to the formula:
$$Cloudiness {Index}_{n t} = {C}_{1} \frac{Pixel {Value}_{n t} - Pixe Value Lower {Limit}_{n t}}{\begin{matrix}Pixel Value Upper {Limit}_{n t} - \\ Pixel Value Lower {Limit}_{n t}\end{matrix}} + {\sum }_{i = 2}^{j} {C}_{i} Infrared {Pixel}_{int}$$
where Cx is a fitted coefficient corresponding to each variable.

10. A method as in claim 8, wherein the step of assuming pixel value constancy across time is performed by a computing device according to the formula:
I(x,y,t)=I(x+∂x,y+∂y,t+∂t)

11. A method as in claim 8, wherein the step of approximating the motion with a Taylor series is according to at least one of the following Taylor series:
$$a . I ( x + \partial x , y + \partial y , t + \partial t ) = I ( x , y , t )$$
$$b . I ( x + \partial x , y + \partial y , t + \partial t ) = I ( x , y , t ) + \frac{\partial I}{\partial x} \partial x + \frac{\partial I}{\partial y} \partial y + \frac{\partial I}{\partial t} \partial t + Higher Order Terms$$
$$c . \frac{\partial I}{\partial x} \partial x + \frac{\partial I}{\partial y} \partial y + \frac{\partial I}{\partial t} \partial t - 0$$
$$d . \frac{\partial I}{\partial x} \frac{\partial x}{\partial t} + \frac{\partial I}{\partial y} \frac{\partial y}{\partial t} = - \frac{\partial I}{\partial t}$$
$$e . ∇ {I}^{T} \cdot \vec{V} = - {I}_{t}$$

12. A method as in claim 8, wherein the step of solving system of m*m equations in the least square sense is according to at least one of the following:
∇I^{T}·\vec{V}=−Iₜ a.
minΣ _{x̅εΩ}W²(\vec{x})[∇I^{T}(\vec{x},t)·\vec{V}+Iₜ(\vec{x},t)]² b.
A^{T}W²A\vec{V}=A^{T}W²b c.
A=[I(x₁), . . . ,I(x_{n•n})]^{T} i.
W=diag(W(x₁), . . . ,W(x_{n•n})) ii.
b=[Iₜ(x₁), . . . ,Iₜ(x_{n•n})]^{T} iii.

13. A method as in claim 8, wherein the step of calculating cloud motion vectors from multiple resolution vector fields is according to:
V₄=V₄′+(((V₃′)_{interpolated}+V₂′)_{interpolated}+V₁)_{interpolated}

14. A computer implemented method of forecasting solar irradiance using optical flow based cloud motion forecasts, said method comprising the steps of:
determining a cloudiness index value transformed from at least one of satellite imagery and sky imagery and generated by a cloud forecasting model at location n at time t;
Applying, by a computing device, a motion vector of a pixel obtained from the cloud forecasting model for a time period length i at location n at time t and at respective locations to the cloudiness index value to forecast each cloudiness index at a forecasted location of pixel and a time of forecast to provide a forecasted cloudiness index;
Inputting, in a computing device, the forecasted cloudiness index as input to a solar irradiance model to estimate solar irradiance at location o at time u.

15. A method as in claim 1, wherein the step of calculating the cloudiness index at each pixel location for time t to provide a cloudiness index image is determined by a computing device using only the time-series of visible satellite imagery and is according to the formula:
$$Cloudiness {Index}_{n t} = \frac{Visible {Pixel}_{n t} - Visible Pixel Lower {Limit}_{n t}}{\begin{matrix}Visible Pixel Upper {Limit}_{n t} - \\ Visible Pixel Lower {Limit}_{n t}\end{matrix}}$$
